(19) United States
(12) Patent Application Publication
(10) Pub. No.: US 2018/0350390 A1
(43) Pub. Date: Dec. 6, 2018

(54) SYSTEM AND METHOD FOR VALIDATING AND CORRECTING TRANSCRIPTIONS OF AUDIO FILES

(71) Applicant: Verbit Software Ltd., Ramat Gan, IL (US)

(72) Inventors: Eric SHELLEF, Givaatayim (IL); Kobi BEN TZVI, Ramat Hasharon (IL); Tom LIVNE, Ramat Gan (IL)

(73) Assignee: Verbit Software Ltd., Ramat Gan (IL)

(21) Appl. No.: 15/859,620

(22) Filed: Dec. 31, 2017

Related U.S. Application Data
(60) Provisional application No. 62/512,267, filed on May 30, 2017.

(51) Int. Cl. G10L 25/51; G10L 15/16; G10L 15/18; G06F 17/21

(52) U.S. Cl. CPC G10L 25/51; G10L 15/16; G10L 25/84; G06F 17/218; G10L 15/1815

(57) ABSTRACT

A system and method for validating and correcting transcriptions of an audio file. The method includes analyzing an audio file to at least identify transcription characteristics of the audio file; comparing a received transcription file to the identified transcription characteristics; and validating the received transcription file to detect errors within the received transcription file.

### CROSS-REFERENCE TO RELATED APPLICATIONS

This application claims the benefit of U.S. Provisional Application No. 62/512,267 filed on May 30, 2017, the contents of which are hereby incorporated by reference.

### TECHNICAL FIELD

The present disclosure relates generally to audio transcription systems, and more specifically a system and method for validating and correcting transcriptions of audio files.

### BACKGROUND

Transcription in the linguistic sense is a systematic representation of language in written form. The source of a transcription can either be utterances (e.g., speech or sign language) or preexisting text in another writing system.

In the academic discipline of linguistics, transcription is an essential part of the methodologies of phonetics, conversation analysis, dialectology and sociolinguistics. It also plays an important role for several subfields of speech technology. Common examples for transcription use employed outside of academia involve the proceedings of a court hearing, such as a criminal trial (by a court reporter), a physician's recorded voice notes (medical transcription), aid for hearing impaired persons, and the like.

Recently, transcription services have become commonly available to interested users through various online web sources. Examples of such web sources include rev.com, transcribeMe®, and similar services where audio files are uploaded by users and distributed via a marketplace to a plurality of individuals who are either freelancers or employed by the web source operator to transcribe the audio file.

However, it can be difficult to properly analyze an audio file in an automated fashion. These audio files are heterogeneous by nature in regards a speaker's type, accent, background noise within the file, context, and subject matter of the audio. As such, transcription of audio files may contain errors, including incorrect words and incorrect associations between words or phrases and a particular speaker. It is often desirable to validate a transcription to check for transcription errors. Such validation often requires human involvement, which can be time consuming, inefficient, and costly.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for validating and correcting transcriptions of an audio file. The method includes analyzing an audio file to at least identify transcription characteristics of the audio file; comparing a received transcription file to the identified transcription characteristics; and validating the received transcription file to detect errors within the received transcription file.

Certain embodiments disclosed herein also include a non-transitory computer readable medium having stored thereon instructions for causing a processing circuitry to perform a process, where the process includes analyzing an audio file to at least identify transcription characteristics of the audio file; comparing a received transcription file to the identified transcription characteristics; and validating the received transcription file to detect errors within the received transcription file.

Certain embodiments disclosed herein also include a system for validating and correcting transcriptions of an audio file, the system including a processing circuitry; and a memory, the memory containing instructions that, when executed by the processing circuitry, configure the system to analyze an audio file to at least identify transcription characteristics of the audio file; compare a received transcription file to the identified transcription characteristics; and validate the received transcription file to detect errors within the received transcription file.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram of a system for validating and correcting transcriptions of audio files according to an embodiment.

FIG. 2 is a flowchart of a method for validating and correcting transcriptions of audio files according to an embodiment.

FIG. 3 is a flowchart of a method for the identification of transcription characteristics of an audio file according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a system and a method for validating and correcting transcriptions of audio files based on an analysis of the content therein. In an embodiment, an audio file and a transcription file of the audio file are received by a server. The audio file is analyzed using one or more speech recognition techniques. Based on the analysis, transcription characteristics are identified. The server may include a validation engine configured to identify the transcription characteristics, where the validation engine is a multi-layer computable engine configured to scan a transcription file and identify incorrect terms therein. The validation engine may further generate a mark within the transcription highlighting any identified errors. In an embodiment, the validation engine is additionally configured to correct identified errors or to provide a suggestion for such a correction.

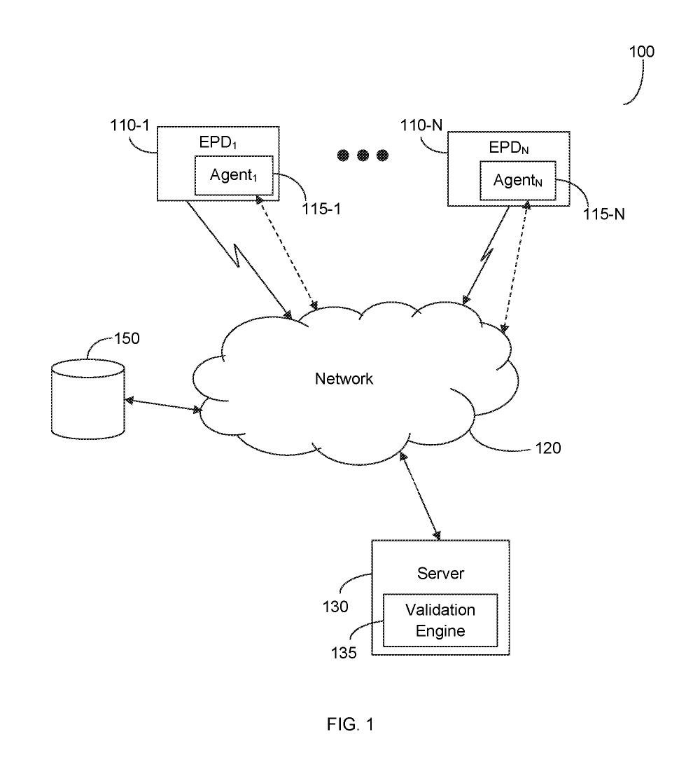

FIG. 1 shows an example diagram of a system 100 for validating and correcting transcriptions of audio files according to an embodiment. A plurality of end point devices (EPD) 110-1 through 110-N (collectively referred hereinafter as end point devices 110 or individually as an end point device 110, merely for simplicity purposes), where N is an integer equal to or greater than 1, are connected to a network 120. The EPDs 110 can be, but are not limited to, smartphones, mobile phones, laptops, tablet computers, wearable computing devices, personal computers (PCs), a combination thereof and the like. The EPDs 110 may be operated by users or entities looking for transcription services for audio files, such as validation of transcriptions.

According to an embodiment, each of the EPDs 110-1 through 110-N has an agent 115-1 through 115-N installed therein, (collectively referred hereinafter as agents 115 or individually as an agent 115, merely for simplicity purposes), respectively, where N is an integer equal to or greater than 1. Each of the agents 115 may be implemented as an application program having instructions that may reside in a memory of the respective EPD 110.

The network 120 may include a local area network (LAN), a wide area network (WAN), a metro area network (MAN), a cellular network, the worldwide web (WWW), the Internet, as well as a variety of other communication networks, whether wired or wireless, and any combination thereof, that are configured to enable the transfer of data between the different elements of the system 100.

A server 130 is further connected to the network 120. The server 130 is configured to receive audio files and transcriptions thereof for assessment, including validation and correction of the transcriptions based on the received audio files. In an embodiment, the audio file, the transcription, or both, may be received from one or more EPDs 110. The server 130 includes a processing circuitry, and a memory (neither shown in FIG. 1). The processing circuitry may be realized by one or more hardware logic components and circuits. For example, and without limitation, illustrative types of hardware logic components that can be used include Field Programmable Gate Arrays (FPGAs), Application-Specific Integrated Circuits (ASICs), System-on-a-Chip systems (SOCs), Complex Programmable Logic Devices (CPLDs), general-purpose microprocessors, microcontrollers, digital signal processors (DSPs), and the like, or any other hardware logic components that can perform calculations or other manipulations of information.

The memory may be volatile, non-volatile, or a combination thereof. The memory contains therein instructions that, when executed by the processing circuitry, configures the server 130 to validate and correct transcriptions of audio files as further described herein.

The system 100 further includes a database 150. The database 150 is configured to store therein information (e.g., metadata, transcriptions, and the like) associated with previous audio file assessments generated by the server 130. The database 150 may be connected to the network 120, or connected directly to the server 130 (not shown). The server 130 is configured to access the database 150 in order to, e.g., compare metadata from a previously analyzed audio file to an audio file currently being analyzed.

The server 130 is further configured to validate and correct transcriptions of audio files. The server 130 receives a request to validate an audio file. In an embodiment, the audio file, a transcription thereof, or both are received by the server. If no transcription is available, the server 130 may be further configured to generate a transcription of a received audio file, using, for example, natural language processing techniques, text-to- speech modules, and the like. In an embodiment, the transcription may be generated based on previously generated transactions, e.g., transcriptions stored in the database 150. Alternatively, the transcription may be received from an external source, e.g., an EPD 110, such as when the transcription has been previously prepared by an individual and stored on a storage device. In a further embodiment, the transcription is received without the audio file, and the server 130 is configured to retrieve a matching audio file, e.g., from the database 150.

The audio file is analyzed by the server 130, wherein the analysis may be performed using one or more deep learning techniques or one or more speech recognition techniques. According to an embodiment, the analysis may at least be partially based on one or more neural networks extracted from the database 150. For example, neural network may include a system for audio characterization that trains bottleneck features from neural networks, e.g., linear and non-linear audio processing algorithms that may be implemented using neural networks for audio processing. The algorithms may include, for example, decision tree learning, clustering, homomorphic filtering, wideband reducing filtering, and sound wave anti-aliasing algorithms.

The analysis includes determining transcription characteristics of the audio file, including a signal to noise ratio, the clarity of recording, the number of speakers captured within the audio file, the accents of each speaker, languages spoken by each speaker, background noises, and the like, a combination thereof, and portions thereof. The transcription characteristics may be determined using one or more deep learning techniques. According to an embodiment, the process of determining the transcription characteristics includes identification of all type of sounds from the audio file, e.g., a main speaker(s), other speaker(s), background noises, white noises, and the like.

According to an embodiment, the transcription characteristics may further include contextual variables associated with the audio file. The contextual variables may include, for example, a topic of the audio file, a source of the audio file, lingual indicators, and the like.

Based on the transcription characteristics, the server 130 is further configured to instantiate, initialize, or trigger a validation engine 135. The validation engine 135 is a multi-layer computable engine configured to scan the transcription and identify incorrect terms therein. In an embodiment, the server 130 includes a validation engine 135 configured to analyze transcription characteristics of a received audio file.

In an embodiment, the validation engine 135 is initialized by server 130. The validation engine 135 may be configured to perform various tasks including, but not limited to, a text to speech (TTS) conversion (i.e., converting an audio input into a textual output), and matching a textual output to a known text to identify similar terms. This allows for identification of incorrect terms within a reference text, e.g., a received transcription file. In an embodiment, the validation engine 135 is configured to identify incorrect terms by comparing the transcription file to the determined transcription characteristics.

In an embodiment, the validation engine 135 is further configured to mark the identified errors or incorrect terms in the transcription file. For example, if the transcription file is saved in a text format, the text of each identified error or incorrect term may be highlighted or bolded. In a further embodiment, the validation engine 135 is further configured to determine a suggested correction or an alternative word or phrase to replace the error or incorrect term. As a non-limiting example, if the context of an audio file may be determined to be concerning a musical group, and multiple mentions of the word “ban” are identified as incorrect, the validation engine 135 may be configured to highlight each instance of the word “ban,” and offer the suggestion of the word “band” in its stead. The suggested correction may be determined based on the aforementioned algorithms or deep learning techniques.

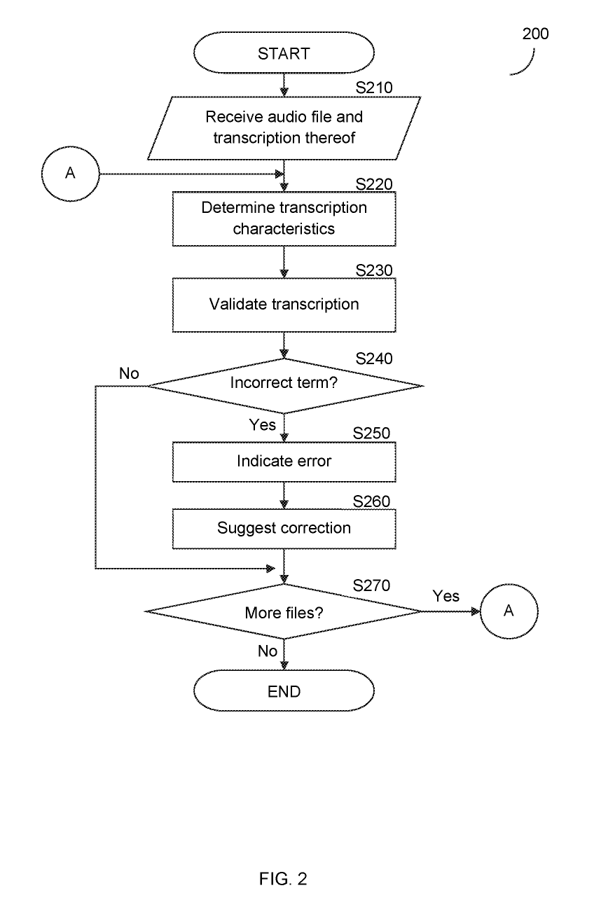

The validation engine 135 may be realized a physical element or a virtual element. A physical element may include a processor, such a DSP, or any logic circuity. In an embodiment, the validation engine 135 is a physical machine connected to the server 130 directly or via the network 120. When realized as a virtual element, validation engine may be a virtual machine, a software container, a serverless function, a physical machine, and so on. It should be noted that a validation engine 135 can be also implemented using combination of hardware, software, firmware, and middleware. FIG. 2 is a flowchart 200 of a method for validating and correcting transcriptions of audio files according to one embodiment. At S210, an audio file and a transcription thereof are received. The audio file or the transcription file may be received over a network, such as the Internet, and may include a recording of one or more speakers. In an embodiment, only the audio file or the transcription file are initially received. If only the audio file is received, a transcription is either requested from an external source, or generated based on the received audio file. Alternatively, if the transcription file is received alone, a matching audio file may be requested from an external source, e.g., a database.

At S220, transcription characteristics are determined, and may include a signal to noise ratio, the clarity of recording, the number of speakers captured within the audio file, the accents of each speaker, languages spoken by each speaker, background noises, and the like, a combination thereof, and portions thereof. According to an embodiment, the transcription characteristics may additionally include contextual variables associated with the audio file, which may include a topic of the audio file, a source of the audio file, lingual indicators, and the like.

At S230, the transcription is validated. The validation includes analyzing the transcription characteristics and comparing them to the received transcription. The validation may include comparing word of a transcription file to a transcription generated from a matching audio file. In an embodiment, the validation is executed by a validation engine.

At S240, it is determined if errors or incorrect terms are is present within the transcription. An error may be identified by comparing a received transcription to a transcription generated from an audio file and determining any differences above a predetermined threshold. If an error or incorrect term is found, the process continues at S250; otherwise, it continues at S270. At S250, identified errors or incorrect terms are marked. For example, if the transcription is in text form, an error may be highlighted or bolded for quick identification.

At optional S260, a correction for the error or incorrect terms is suggested. For example, if an incorrect word is detected within the transcription, a correct or more appropriate word may be suggested in its place. The correction may be determined based on the transcription characteristics, and may include determining the context of a word or phrase and comparing the determined context is similar words or phrase, such as from a previously analyze transcription accessible from a database. As another example, if a phrase determined to be attributed to a first person is incorrectly attributed to a second person within the transcription, the correct attribution may be suggested. In an embodiment, the correction is sent to a user device, e.g., over a network.

At S270, it is determined if there are more audio files and transcription files to be analyzed. If so, execution continues at S220; otherwise execution ends.

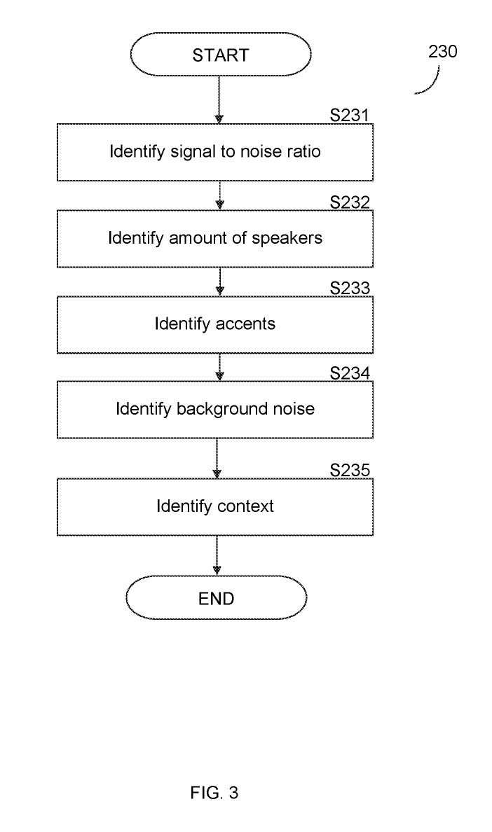

FIG. 3 depicts an example flowchart 300 describing the operation of a method for generating transcription characteristics based on an audio file received according to an embodiment.

At S231, a signal to noise ratio of the audio within the audio file is determined. A signal-to-noise ratio (SNR) is a measure that compares a level of a desired signal to a level of background noise. It is defined as the ratio of signal power to the noise power, and may be expressed in decibels. The desired signal, e.g., the most prominent voice detected within an audio file, may be identified in real time by comparing the value of the signal power to the noise power. For example, the SNR may be defined as equal to the acoustic intensity of the signal divided by the acoustic intensity of noise. Alternatively, the SNR may be calculated by determining a section of the audio file that contains the desired signal and noise to a section of the audio file that only contains noise. The SNR may be determined by dividing the amplitude of former by the amplitude if the latter.

At S232, the number of speakers in the audio file is identified. The identification may be achieved by generating a signature for each voice determined to be unique within the audio file. At S234, background noise in the audio file is identified. Background noise can include, e.g., white noise present throughout an entire recording, distinct sounds determined to be unwanted (e.g., a doorbell or a phone ringtone), artificial audio artifacts present within the audio file, and the like.

At S233, accents are identified within the audio file, i.e., accents for each speaker based on an associated signature. Example for such accent identification may include an implementation of a Gaussian mixture model (GMM), e.g., via a GMM Support Vector Machine (SVM) or GMM Universal Background Model (UBM), i-Vectors, and the like.

At optional S235, contextual variables associated with the audio files are identified, wherein the contextual variables include, but are not limited to, a topic of the audio file, source of the audio file, lingual indicators, and the like.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for validating and correcting transcriptions of an audio file, comprising:
analyzing an audio file to at least identify transcription characteristics of the audio file;
comparing a received transcription file to the identified transcription characteristics; and
validating the received transcription file to detect errors within the received transcription file.

2. The method of claim 1, further comprising:
marking the identified errors within the transcription file.

3. The method of claim 1, further comprising:
suggesting corrections for the identified errors.

4. The method of claim 1, wherein the transcription characteristics include at least one of: a signal to noise ratio, a clarity of recording, a number of speakers captured within the audio file, accents of each speaker, languages spoken by each speaker, background noises, and contextual variables.

5. The method of claim 4, wherein each of the contextual variable includes at least one of: a topic of the audio file, a source of the audio file, and lingual indicators.

6. The method of claim 1, wherein the analyzing the at least one audio file further comprises:
employing a deep learning technique.

7. The method of claim 6, wherein the deep learning technique includes as least one of: a neural network algorithm, a decision tree learning algorithm, a clustering, homomorphic filtering algorithm, a wideband reducing filtering algorithm, and a sound wave anti-aliasing algorithm.

8. A non-transitory computer readable medium having stored thereon instructions for causing a processing circuitry to perform a process, the process comprising:
analyzing an audio file to at least identify transcription characteristics of the audio file;
comparing a received transcription file to the identified transcription characteristics; and
validating the received transcription file to detect errors within the received transcription file.

9. A system for validating and correcting transcriptions of an audio file, comprising:
a processing circuitry; and
a memory, the memory containing instructions that, when executed by the processing circuitry, configure the system to:
analyze an audio file to at least identify transcription characteristics of the audio file;
compare a received transcription file to the identified transcription characteristics; and
validate the received transcription file to detect errors within the received transcription file.

10. The system of claim 9, wherein the system is further configured to:
mark the identified errors within the transcription file.

11. The system of claim 9, wherein the system is further configured to:
suggest corrections for the identified errors.

12. The system of claim 9, wherein the transcription characteristics include at least one of: a signal to noise ratio, a clarity of recording, a number of speakers captured within the audio file, accents of each speaker, languages spoken by each speaker, background noises, and contextual variables.

13. The system of claim 12, wherein each of the contextual variable includes at least one of: a topic of the audio file, a source of the audio file, and lingual indicators.

14. The system of claim 9, wherein the analyzing the at least one audio file further comprises:
employ a deep learning technique.

15. The system of claim 14, wherein the deep learning technique includes as least one of: a neural network algorithm, a decision tree learning algorithm, a clustering, homomorphic filtering algorithm, a wideband reducing filtering algorithm, and a sound wave anti-aliasing algorithm.

16. The system of claim 9, wherein validating is executed by a validation engine configured to identify the transcription characteristics and detect errors by comparing the transcription file to the identified transcription characteristics.
